(19) United States
(12) Patent Application Publication
(10) Pub. No.: US 2013/0339112 A1
(43) Pub. Date: Dec. 19, 2013

(54) Method and Apparatus for Network Code Assignment Responsive to Transaction with Option for Game Play Award

(71) Applicant: Panayis Nicola Palexas, Krugersdorp (ZA)

(72) Inventor: Panayis Nicola Palexas, Krugersdorp (ZA)

(21) Appl. No.: 13/921,088

(22) Filed: Jun. 18, 2013

Related U.S. Application Data
(60) Provisional application No. 61/661,342, filed on Jun. 18, 2012.

(51) Int. Cl. G06Q 30/02

(52) U.S. Cl. CPC G06Q 30/0209
USPC 705/14.12

(57) ABSTRACT

A system and method for execution on a computer network such that upon sale of a product or service of a qualifying product or service from a network accessible e-commerce site, the purchaser is provided credits or a code redeemable for credits. The purchaser provides payment for the goods or services and a portion of the payment is provided to a game/promotion provider. The system sends purchase data including data regarding the credits or code to a game server associated with a game or promotion. The promotion includes a game playable with the credits or code redeemable for credits. Monitoring of game play occurs and responsive to the purchaser meeting one or more predetermine criteria the system presents an award to the purchaser based on the number of credits remaining after meeting the one or more predetermined criteria.

### 1. PRIORITY CLAIM

This application claims priority to U.S. Provisional Patent Application No. 61/661,342, titled Method and Apparatus for Network Code Assignment Responsive to Transaction with Option for Game Play, filed Jun. 18, 2012.

### 2. FIELD OF THE INVENTION

The invention relates to promotional system and in particular to a method and apparatus for increasing product or service sales by providing gaming credits, which are redeemable for an award upon sufficient play through.

### 3. RELATED ART

Product and service sales are a foundation of every economy and market place transactions. It is well understood that sales of goods and services occurs on a daily basis and that these sales occur for a number of different reasons. While traditional sales arrangements occurred at physical stores where a customer could immediately obtain the products, the advance of the Internet has driven e-commerce and web based sales.

While traditional sales arrangements often relied on which seller was physically closest, e-commerce solutions involve shipping the product to the purchaser. As a result, in e-commerce situations the price or factors other than physical location of the seller play a factor in the selection of which seller is chosen to purchase the goods/services. Most often the deciding factor for the purchaser is price, but price reductions can be offered by any seller, and the typical outcome of lowering of prices by all sellers is reduced profit margins.

Moreover, any one seller is in competition will all other similarly priced sellers, which reduces that particular seller's market share. Each seller must rely on expensive advertising to generate more traffic and potential sales. Also competing with sellers for web traffic are countless other web sites which compete for web traffic. In a commercial setting this web traffic is used to generate advertising revenue or to increase sells of the products or services. Therefore, it is desirable to have Internet users visit a web site and when visiting achieve a sale of a product or service.

Numerous arrangements have been devised to increase product sales or increase traffic to a web site, but these prior art arrangements suffer from numerous drawbacks. To provide benefits in the environment described above and in other environments, the following provides a method and system for product and service promotion to increase sales and further increase traffic to a web site.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### SUMMARY

The traditional retailer often provides typical discounts or cash rebates to their customers. For example 25% off on holidays or 30% cash back on selected items. These typical vendor discounts are common and are used to entice customers to make purchases with that vendor or used to bring more traffic to their stores or web sites in hopes of making additional sales.

Because the vendor is willing to give up 25% of the purchase prices (or more or less) to entice a customer to make a purchase or to invite customers to the vendor's store or web site, the 25% discount becomes a promotional budget that can be used to increase product sales. The 25% of the purchase price may also be used to provide more value to their customers other than just a traditional 25% off retail price.

It is further contemplated that the 25% promotional discount may be pooled to create a larger value. This large pooled value would have otherwise been passed on as a discount or rebate to the purchaser. For example, if a vendor predicts sales of $1,000,000 from 1000 purchases and instead of offering 25% discount to its customers it offered the $250,000 to a promotional program. The promotional program would be able to offer the following value to the purchases instead of the traditional discount.

For every purchase made the customer would receive free credits to play a game, example if a customer spent $100, the customer could receive 100 free credits to play a game.

If the customer was able to achieve a play through challenge or restriction he would be able to cash-in all remaining credits for cash. Example. If the restriction has a 30× wagering restriction then the customer would require them to wager 3000 in total on a 100 credit start point (100×30). On completion of the play-through the customer is able to cash-in credits remaining, or receive another award.

The $250 000 would be able to be re distributed back to the customers in the form of varying cash prizes. It is contemplated that some may not win or be awarded anything others would win $200, $500, $1000 up to large prize in the hundreds of thousands. As a result, every purchaser now has the opportunity to receive a product, receive credits or other opportunities to play games and potentially win prize money for every purchase made. Vendors benefit from increased sales and additional traffic and potentially decreased discount amounts, and game providers receive site traffic and a portion of the discount amount.

To overcome the drawbacks of the prior art and to provide additional benefits, disclosed herein is a method for promoting sales of a product or service. In one exemplary method of operation, the system receives notice from a network accessible e-commerce site that sale of a qualifying product or service in exchange for a payment has occurred. From this sale, the system receives a portion of the payment from the network accessible e-commerce site and responsive to the receiving notice, granting the purchaser credits or a code redeemable for credits. The method of operation executed by the system sends purchase data including data regarding the credits or code to a server associated with a promotion. In this embodiment, the promotion includes a game playable with the credits or the code redeemable for credits. The method also presents a game to the purchaser at a network accessible game server and accepts, from the purchaser, credits granted as part of the purchase to thereby allow the purchaser to play the game such that the credits are accepted as opportunities to play the game. Responsive to the purchaser receiving a winning outcome, the method of operation provides additional credits or opportunities to play the game. Monitoring of game play also occurs when played by the purchaser or player, which maybe the same individual. Responsive to the purchaser meeting one or more predetermined criteria the method of operation presents an award to the purchaser based on the number of credits remaining after meeting the one or more predetermined criteria.

In one embodiment the predetermined criteria comprises achieving a predetermined play-through amount which is a multiple of the number of credits provided to the purchaser for the purchase. The credits or code may not have monetary value. The game may comprise a wagering game that does not provide a monitory payout in response to game play but only in response to the meeting one or more predetermined criteria and having one or more credits remaining after meeting the one or more predetermined criteria. In one configuration, the credits are provided for free to the purchaser upon purchase of the product for sale, or for free by a non-purchaser upon request by the non-purchaser. It is contemplated that this method of operation may further include providing at least a portion of the payment paid to the network accessible e-commerce site to an entity associated with the promotion.

Also disclosed herein is an e-commerce method performed by a promotion operator. In one configuration this method comprises establishing a communication link with a e-commerce seller. In this embodiment the e-commerce seller has an e-commerce web site configured to provide a purchaser at the e-commerce web site with credits for game play upon purchase at the e-commerce web site. The purchase includes a purchase payment to the e-commerce seller. Upon a qualifying purchase at the e-commerce web site the method of operation provides credits to the purchaser and receives a portion of the purchase payment from the e-commerce web site. The method also presents a game at a network accessible gaming web site such that the game is playable using the credits. This method monitors one or more aspects of game play for a predetermined event and upon detecting the predetermined event, determines if the player has any credits remaining. Responsive to the player having credits remaining at the time of the detection of the predetermined event the player is provided with an award.

In one configuration the award is a monetary amount representative of the number of credits remaining upon the detection of the predetermined event. The credits may only have monetary value when the player achieves the predetermined event. This method may also include providing credits to a non-purchasing player upon written request by the non-purchasing player. The award may comprise a gift card to the e-commerce web site. In one embodiment the method further comprises accepting payment from the player for additional credits at the network accessible gaming web site such that the additional credits usable to play the game. The game may comprise a game selected from the group of games consisting of poker, slots, keno, and bingo.

Also disclosed is a system for presenting selling a product in connection with a promotion. In one example configuration, this system includes a processor in communication with a memory. The processor is configured to execute machine readable code. A memory is provided and configured to store machine readable code in a non-transitory state. The machine readable code is configured to establish communication with an e-commerce web site, the e-commerce web site providing a purchaser at the e-commerce web site with credits for game play upon the purchase at the e-commerce web site of product or service. The purchase includes a purchase payment made to the e-commerce web site by the purchaser. Upon a purchase occurring at the e-commerce web site, the purchaser is provided credits. The machine readable code is also configured to accept a portion of the purchase payment from the e-commerce web site and present a game to the purchaser at a network accessible gaming web site. The game is playable using the credits. One or more aspects of game play is monitored by the code to detect a predetermined event. Upon detecting the predetermined event, the machine readable code is configured to determine if the player has any credits remaining. Responsive to the player having credits remaining at the time of the detection of the predetermined event, the code is configured to providing the player with an award. The term player and player account may be used interchangeably. The terms purchaser and player may be defined as the same person or entity if the purchaser also uses the credits and thus becomes a player.

In one embodiment the predetermined event comprises a requirement that the purchaser wager a predetermined amount of game wagers. The predetermined event may comprise one of the follow: game play for predetermined period of time, a number of hands played where the game comprises a card game, or a number of round play where the game comprises slots. In one variation the credits are provided to an account associated with the purchaser or through use of a code, which is redeemable for credits. In one configuration, the credits do not have a monetary value and can only be used to play the game. The product or service may be a gift card or a certificate for a future purchase of a product or service. It is contemplated that the amount of the award is based on the number of credits remaining at the time of the detection of the predetermined event.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating the physical or virtual elements and participants in the method and apparatus disclosed herein.

FIG. 2 is a block diagram of an example embodiment of a client device, such as a computer or mobile computing device.

FIG. 3 is a block diagram illustrating an exemplary transaction process.

FIG. 4 illustrates an operation flow diagram of an example method of establishing the physical elements and participants.

FIGS. 5A and 5B illustrate an operation flow diagram of an example method of operation.

FIG. 6 illustrates an operational diagram for player registration.

FIG. 7 illustrates an operational diagram for processing traffic received via game provider.

FIG. 8 illustrates an operational diagram for downloading the game, data, or other content.

FIG. 9 illustrates an operational diagram for installing the game, data, or other content to the player or purchaser (user) computing device.

FIG. 10 illustrates an operational diagram for making a purchase at a vendor web site or other location to obtain credits.

FIG. 11 illustrates an operational diagram for downloading the game, data, or other content.

FIG. 12 illustrates a flow diagram of an example play through calculation.

### DETAILED DESCRIPTION

In general, the innovation is a method for marketing and advertising products to encourage purchase of goods or services while also signing up additional players to a gaming web site or establishment. To aid in understanding, the following definitions of the primary participants and terms are provided.

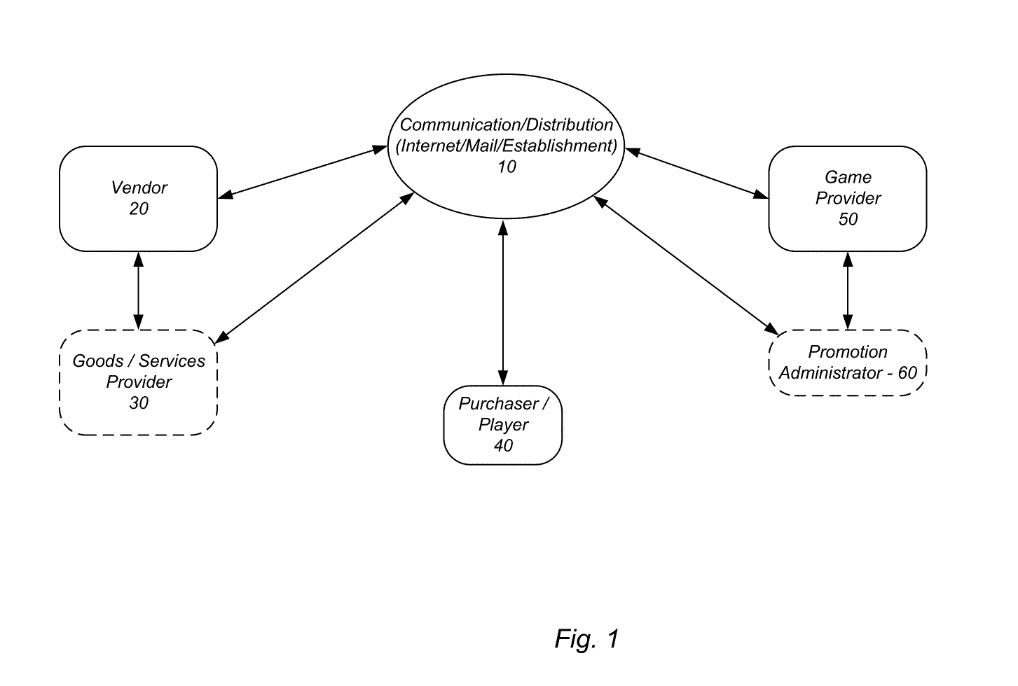

FIG. 1 is a block diagram illustrating the physical elements and participants in the method and apparatus disclosed herein. The following defines the participants and elements in the method described below.

Vendor—the vendor is a company that sells goods or services, such as Amazon.com or Itunes.com store. The good may be any type goods, services, or electronic based items of value, such as MP3 songs or movies. The vendor could be a land based casino or resort.

Good/Service Provider—the good/service provider may company any company that has a relationship with the vendor to provide goods and services ordered through the vendor to a purchaser. This may include drop shipping or arrangements where the vendor is an agent of the good/service provider or the vendor is a third party business that performs sales functions for the good/service provider. The good/service provider may not be required or exist in all embodiments.

Game provider (also referred to as a sponsor)—the game provider, which may be a casino company is an online gaming company (wagering or non-wagering) which offers online gaming. The game provider has a relationship with the Vendor as is described below. The game provider offers free credits to a purchaser when the purchaser/player signs up with the game provider and purchases goods or services with the vendor. The game provider offers free credits to a purchaser when the purchaser/player signs up with the game provider or with a promotion administer. In one embodiment the game provider has a web site that offers on-lines games, which may be wagering games, where the purchaser/player may wager credits as part of the game.

Promotion Administrator—the promotion administer is an entity or company established to oversee the promotion and track or monitor one or more aspects of the promotion. In one embodiment the promotion administrator also offers credits for play on the game provider web site or physical location without any purchase being made. The promotion administrator may be a web site. The promotion administer may perform accounting and validation of credits/purchases to the purchaser/player. The promotion administer may not be required or exist in all embodiments.

Purchaser/player—The purchaser/player is a person who signs up at the game provider web site and then purchases goods or services from the vendor using a click through link or code from the game provider. The purchaser/player will then receive the goods and services from the vendor and the free credits from the game provider. This may also be known as or referred to as an affiliate program, which is an arraignment known in the art and thus described in detail herein.

Credits—credit may be bet at the game provider web site when gaming online. The credits are not cash or cash equivalents, but instead are play opportunities. The credits may also be a type of credit used in virtual a game. Credits may also comprise tokens or any other voucher.

Gaming Awards—Gaming awards are awards that are presented to the purchaser/player when the purchaser/player achieves a predetermined play through. Play through is the number of times a player needs to bet or play using the provided credits in order to qualify for an award. Play through is discussed below in greater detail.

Internet—The term Internet as used herein may comprise any network or communication system capable of exchanging information between two or more locations.

Communication/Distribution—the communication/distribution element comprises any combination of elements that provide for the exchange of information, such a computer or network based communication, and/or mail or shipping based distribution services for the distribution of goods or other items between the various entities shown and described herein and as otherwise known in the art. The Internet may be part of the communication/distribution element.

In reference to FIG. 1, the various entities are shown generally. Although shown in one particular environment and embodiment, it is contemplated that other methods and system arrangements may be developed which do not depart of the innovation as contemplated by the inventor. The following elements may be computer web sites executing on a server/database, or physical locations of business.

As described herein, the purchaser/player 40 is an entity, such as an individual may desire to purchase a product or service and to do so either online, by phone, or in person. The purchaser/player 40 may contact the vendor 20 through the communication aspects or elements of the communication/distribution network 10 to order or purchase the goods. When the purchaser/player 40 has a purchasing decision the purchaser/player may have numerous sellers from which to choose. In this embodiment if the purchaser/player 40 purchases goods or services from the vendor 20, the purchaser/player will be also provided credits. Receipt of these credits from the vendor 20 incentives the purchaser/player to purchase from the vendor, which in turn increases sales by the vendor or increases the price at which the vendor may sell its products or services. These credits are for use game play by the purchaser/player 40 at the game provider 50 location or web site.

Numerous variations are contemplated and within the scope of the disclosure. The credits or code which is redeemable for credits may be established at the game provider or the operator of the promotion, or alternatively created, credited to the purchaser account or provided by the vendor. The vendor may be an e-commerce web site. There may also exist a referral arrangement between the game provider (web site) and the vendor such that purchasers visiting the vendor site from the game provider site are tracked and to these shoppers the code or credits are provided. It is also contemplated that the code or credits may be shown as part of the products which are purchased and thus the purchaser knows that they will receive credits or a code for credits and the number of credits. Any type affiliate program now known or developed in the future may be established to establish the interaction between the vendor server, purchaser computer, and game provider server.

By way of example, a vendor will have a vendor server presenting a web site presented from the network accessible vendor server. The vendor web site is configured to communicate over a packet network with a purchaser computer (or smartphone or tablet) to perform product or service ordering. A game provider server offers a gaming server. The purchaser, who receives the credits or code for credits may access the vendor server using the purchaser computer. Data may be exchanged between the vendor web site and the game provider server (who may also be the promotion operator) as part of the purchase. During the purchase, the vendor server and/or the purchaser server may communicate over a computer network, such as the Internet, with the game provider web site at the game provider server. The exchange may

The vendor 20 offers goods or services for sale over the Internet or for pick-up from a physical store. In the case of services, the vendor may sell services which are provided to the purchaser/player 40 or which the purchaser/player travels to receive. For example, the vendor 20 may sell goods on a e-commerce web site for shipment to the purchaser/player 40 or the vendor could be a physical resort or casino to which the purchaser/player travels to for a vacation, entertainment or gambling.

The vendor 20 communications with one or more other elements shown in FIG. 1 through the communication/distribution network 10. Communication may occur over a computer/server network using any networking standard, such as HTTP or HTML based communication with or without security. In the event the vendor 20 has a relationship with a third goods/service provider 30 then the vendor would communication order information to the goods/service provider 30 for fulfillment. In such an arrangement, the goods/service provider 30 would send the goods to the purchaser/player 40 through network 10, such as by shipping a physical package. This package would be received by the purchase/player 40 or another entity designed by the purchaser/player. The goods may also be downloaded, such as in the case of a movie, song or other digital content. The goods/service provider 30 may be the same as or affiliated with the vendor or a third party that is just in contractual relationship with the vendor.

It is contemplated that the purchase may have account or may establish an account with the game provider web site, which executes on the game provider network. When making a purchase, the purchaser may enter their game provider account into the vendor web site, and the vendor web site will communicate the purchase information to the game provider web site. As a result, the game provider web site may provide the credits to the purchasers account.

In one embodiment the purchaser may receive a code at the time of purchase. The code may be provided to the purchase by the vendor web site and the code may be redeemable for credits. The code could also be provided to the purchaser, upon making a purchase, by the game provider web site or credited to the purchase's account. Often the codes or credit control will be generated by or controlled by the game provider web site to reduce or prevent fraud.

In one configuration the vendor server may notify the game provider server when a purchaser makes a purchase which qualifies for credits. This may be referred to as a qualified purchase. This notification may take any form. Upon notification the game provider would provide the credits, such a updating the player account, with the credit information.

The game providers provide one or more games for play by a purchaser/player 40 using the credits provided to the purchaser/player when the purchaser/player made a purchase at a vendor 20. The game provider 50 may maintain a web site where players may use credits to wager online at one or more wagering games or other type games or events, such as sports wagering or non-wagering games. The game provider could also be a physical location or event at which the purchaser/player 40 may use the credits by playing a game or participating in another event. The providing of credits may be referred to herein and in one optional configuration a promotion administrator 60 may be provided which aids in the administration of the promotion such as by tracking which purchaser/players have credits and verifying that purchases and payments were made to award those credits to the players. The promotion administrator may be an independent party.

The game provider 50 or the promotion administrator 60 may also accept request for credits from third parties who did not purchase any goods or services from the vendor 20. These third parties may also enter into the promotion, even though they did not purchase any goods or services to receive credits which may be played at the game provider 50. Credit awards may be in the form a code or other identifier which the purchaser/player may use to redeem the credits at the game provider 50.

The number of credits provided to the purchaser may be fixed based on any purchase, or provided in an amount that relates to the amount spent or the product purchased. In one embodiment the number of credits is based on the product purchased. It is contemplated that credits may also be purchased independent of a product, or provided for free upon request.

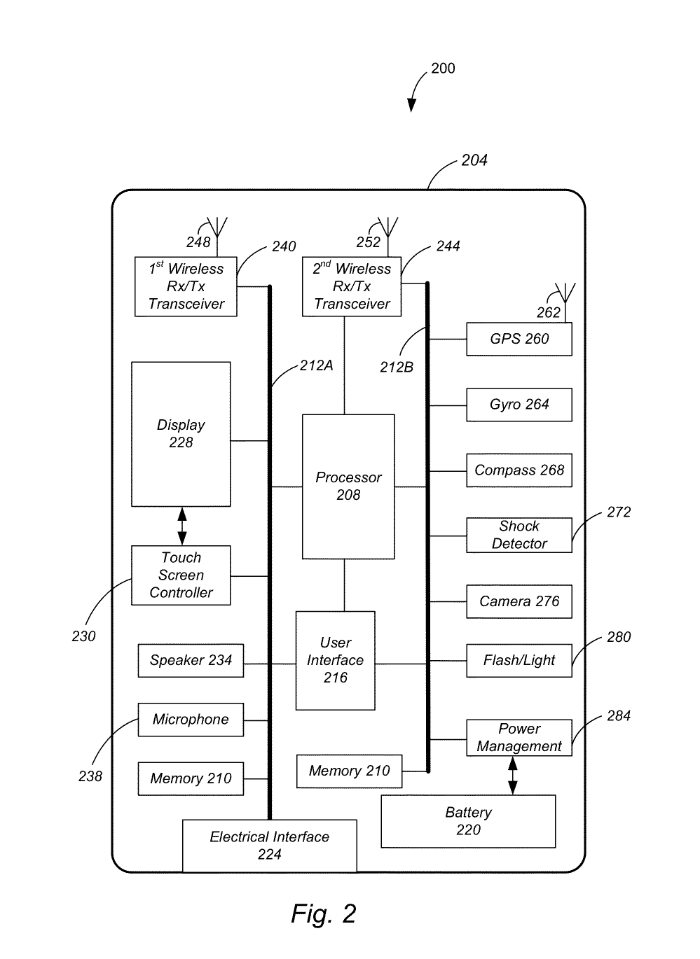

FIG. 2 illustrates an example embodiment of a client device or computer that may be used by one or more entities described in FIG. 1. The client device may comprise a computer, server, network component, mobile device such as an Iphone or similar smartphone, or a laptop. This is but one possible client device configuration and as such it is contemplated that one of ordinary skill in the art may differently configure the client device. The client device 200 may comprise any type computing device capable of performing as described below. It is also contemplated that the computer 124 or mobile device may be similarly configured, but lacking certain elements in the event it is configured as a desktop and is not portable.

In this example embodiment, the client device 200 is configured with an outer housing 204 configured to protect and contain the components described below. Within the housing 204 is a processor 208 and a first and second bus 212A, 212B (collectively 212). The processor 208 communicates over the buses 212 with the other components of the client device 200. The processor 208 may comprise any type processor or controller capable of performing as described herein. The processor 208 may comprise a general purpose processor, ASIC, ARM, DSP, controller, or any other type processing device. The processor 208 and other elements of the client device 200 receive power from a battery 220 or other power source such as a wall plug. An electrical interface 224 provides one or more electrical ports to electrically interface with the client device, such as with a second electronic device, computer, a network connection such as to a local network or to the Internet, or one or more user interfaces such as a mouse or keyboard, or a power supply/charging device. The interface 224 may comprise any type electrical interface or connector format.

One or more memories 210 are part of the client device 200 for storage of machine readable code (software) for execution on the processor 208 and for storage of data and software code which is machine readable and executable by a processor, or any other type of data. The memory may comprise RAM, ROM, flash memory, optical memory, hard disk drive or micro-drive memory.

As part of this embodiment, the processor 208 connects to a user interface 216. The user interface 216 may comprise any system or device configured to accept user input to control the client device. The user interface 216 may comprise one or more of the following: keyboard, roller ball, buttons, wheels, pointer key, touch pad, and touch screen. A touch screen controller 230 is also provided which interfaces through the bus 212 and connects to a display 228.

The display comprises any type display screen configured to display visual information to the user. The screen may comprise a LED, LCD, thin film transistor screen, OEL, TFT (thin film transistor), TFD (thin film diode), OLED (organic light-emitting diode), AMOLED display (active-matrix organic light-emitting diode), capacitive touch screen, resistive touch screen or any combination of these technologies. The display 228 receives signals from the processor 208 and these signals are translated by the display into text and images as is understood in the art. The display 228 may further comprise a display processor (not shown) or controller that interfaces with the processor 208. The touch screen controller 230 may comprise a module configured to receive signals from a touch screen which is overlaid on the display 228.

Also part of this exemplary client device is a speaker 234 and microphone 238. The speaker 234 and microphone 238 may be controlled by the processor 208 and thus capable of receiving and converting audio signals to electrical signals, in the case of the microphone, based on processor control. Likewise, processor 208 may activate the speaker 234 to generate audio signals. These devices operate as is understood in the art and as such are not described in detail herein.

Also connected to one or more of the buses 212 is a first wireless transceiver 240 and a second wireless transceiver 244, each of which connect to respective antenna 248, 252. Wireless devices are optional. The first and second transceiver 240, 244 are configured to receive incoming signals from a remote transmitter and perform analog front end processing on the signals to generate analog baseband signals. The incoming signal maybe further processed by conversion to a digital format, such as by an analog to digital converter, for subsequent processing by the processor 208. Likewise, the first and second transceiver 240, 244 are configured to receive outgoing signals from the processor 208, or another component of the client device 208, and up convert these signal from baseband to RF frequency for transmission over the respective antenna 248, 252. Although shown with a first wireless transceiver 240 and a second wireless transceiver 244, it is contemplated that the client device 200 may have only one such system or two or more transceivers. For example, some devices are tri-band or quad-band capable. Some embodiment may not include wireless communication.

It is contemplated that the client device, and hence the first wireless transceiver 240 and a second wireless transceiver 244 may be configured to operate according to any presently existing or future developed wireless standard including, but not limited to Bluetooth, WI-FI such as IEEE 802.11a,b,g,n, wireless LAN, WMAN, broadband fixed access, WiMAX, any cellular technology including CDMA, GSM, EDGE, 3G, 4G, 5G, TDMA, AMPS, FRS, GMRS, citizen band radio, VHF, AM, FM, and wireless USB.

Also part of the client device is one or more systems connected to the second bus 212B which also interface with the processor 208. These devices include a global positioning system (GPS) module 260 with associated antenna 262. The GPS module 260 is capable of receiving and processing signals from satellites or other transponders to generate location data regarding the location, direction of travel, and speed of the GPS module 260. GPS is generally understood in the art and hence not described in detail herein. A gyro 264 connects to the bus 212B to generate and provide orientation data regarding the orientation of the client device 204. A compass 268 provides directional information to the client device 204. A shock detector 272 connects to the bus 212B to provide information or data regarding shocks or forces experienced by the client device.

One or more cameras (still, video, or both) 276 are provided to capture image data for storage in the memory 210 for possible transmission over a wireless or wired link or viewing at a later time.

A power management module 284 interfaces with or monitors the battery 220 to manage power consumption, control battery charging, and provide supply voltages to the various devices which may require different power requirements. Software may be enabled on the client device for communication over a network such as using the Internet to enable on-line purchase, sending and receiving of messages, and online game play.

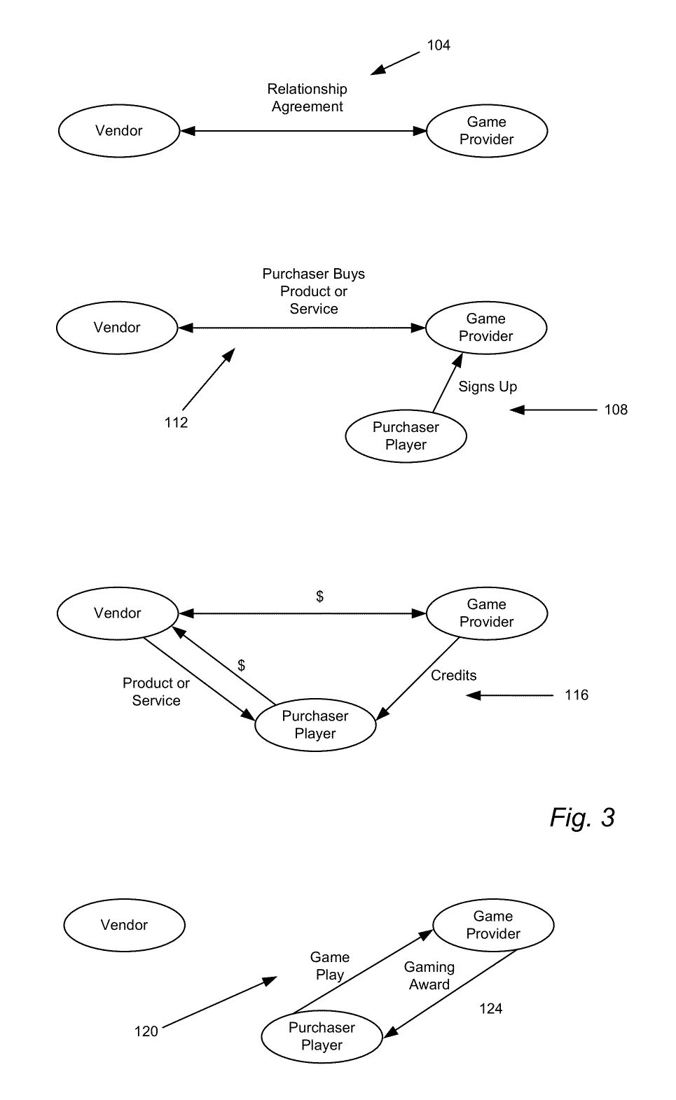

FIG. 3 is a block diagram illustrating an exemplary transaction process. This is but one possible method of operation and as such other methods of operation or transaction may occur without departing from the scope of the innovation. At a step 104 the vendor and the game provider establish an agreement. In one embodiment the relationship is such that the vendor agrees to provide compensation to the game provider for products which are purchased by a purchaser/player either through the game provider web site or using a game provider code.

At a step 108, a purchaser/player signs up at the game provider. The sign up process may comprise any sign up process such as but not limited to receiving a password or code.

At a step 112, as part of the sign up or thereafter, the Purchaser/player buys a product or service from the vendor. This may occur using a click through link or code assigned by the game provider to the purchaser/player. The purchaser/player is encouraged to purchase through the vendor (who has a relationship with the game provider) because when doing so they receive free credits for game play from the game provider. The credits may comprise any game benefit such as credits which enable play, or credits used within a game to virtually purchase goods or unlock benefits.

At a step 116 the transaction occurs such that the Purchaser/player pays money to the vendor. A portion of this money is forwarded or paid to the game provider for initiating the transaction or referring the purchaser to the vendor. The purchaser/player receives the product or services from the vendor and credits from the game provider. The credits may be considered a free bonus to the purchaser/player and incentivize the purchaser/player to purchase through the game provider click through or using the code from the game provider. The credits are used by the purchaser/player to play a game at the game provider web site.

At a step 120, the purchaser/player plays the game using the credits. The game may comprise any game such as a wagering type casino style game (played without money but using the credits). The player, which may have been the purchaser, may have a player account which is associated with the player. The player account information may be stored in a database in a memory associated with the game server. The player credits and amount of play or play history may be stored on the memory.

During play, the play of the purchaser/player is tracked to determine how many credits the player bets total during play. This is defined as ‘play through’. For example, if the player receives 100 credits and over the course of time, wagers 200 credits total from the original 100 credits, then there is a 200% play-through. This amount of play through may be any predetermined number. The play through may be considered a predetermined event which the player must stratify to receive a prize. Other aspects may be tracked such as amount of time playing or completion of a particular level in the game. If sufficient play through occurs, then at a step 124, the player is entitled to a gaming award. This gaming award is not an award resulting from a winning wager, simply meeting a play through requirement or play time requirement. The award can be selected based on the credits remaining after the player has played the game and achieved the predetermined play through, a fixed monetary award, or physical prize such as a product or other item of value.

It is also understood in the art how Internet sites and interconnections work and operate such that one or more computer connect through a vast network of interconnected computers and servers. Interconnecting the computers, such as client device and serve is a network of cabling, routers, switches and other related devise. Associated with the servers may be one or more databases which store code and information representing the web pages. User may communicate with the remote serves to interact with the software and database located thereon. One or more interfaces provides for the exchange of purchase information, such as credit card processing, to facilitate purchase of the goods using a credit card. E-mail or text message, or information printed on paper which is provided with the product may be used to provide the code or a receipt to the purchaser/player.

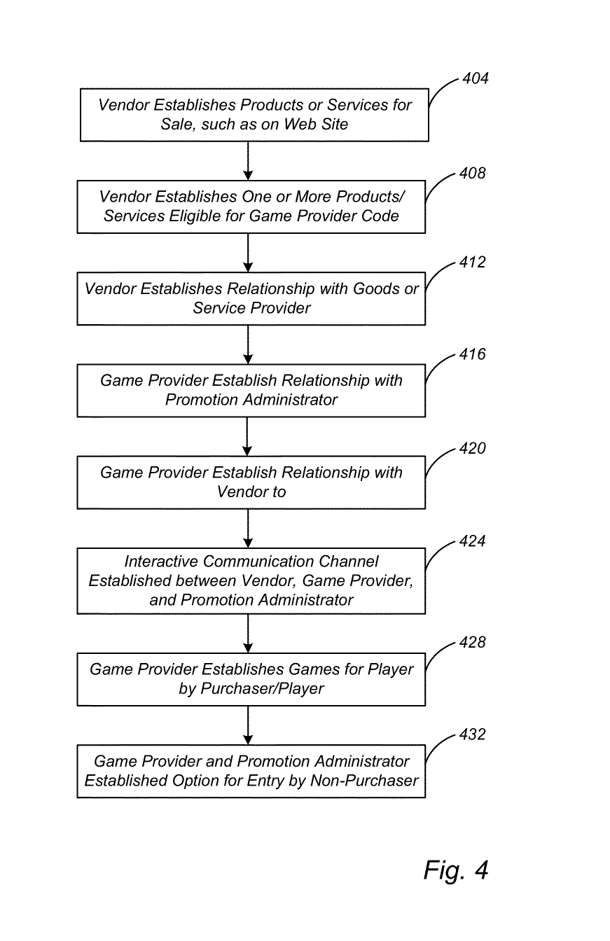

FIG. 4 illustrates an operation flow diagram of an example method of establishing the physical elements and participants. This is but one possible methods of operation and other methods or arrangements are contemplated. At a step 404 the vendor establishes products or services for sale on a web site, by phone, or at a physical location. Then at a step 408 the vendor establishes or associates a code with the products or establishes that one or more products are available for receipt of a code with purchase. Hence, when a purchaser/player purchases one of these products the purchaser also receives a code or credits. The code may be redeemable for credits.

At a step 412 the vendor establishes a relationship with a goods/service provider if the vendor itself is not going to supply the goods or services. This relationship would establish the goods/service provider and packaging and shipping the goods to the purchaser. It is contemplated at step 416 the game provider may also establish a relationship with a promotion administrator to oversee the promotion as described herein. This may include the establishment of one or more databases which contain the codes, purchases, payments and credits.

At a step 420 the game provider establishes a relationship with the vendor. This step may occur earlier in the method also such as at or near step 408. The relationship may include the agreement for the vendor to provide the code or credits to the purchaser, which are usable at the game provider web site or physical location, and that the vendor will provide a cash payment or other compensation to the game provider for purchases of products or services which include the code. At a step 424 the interactive communication channel, such as over the Internet, is established between the vendor, game provider, and/or promotion administrator. Also part of this group may be the purchaser player. This step may comprise enablement of network connects, web site, servers, and the like for each entity.

At a step 428 the game provider establishes one or more games for play by the purchaser/player 428 such as games which may be played online over the Internet and which may be wagering games using credits. At a step 432 the game provider and/or promotion administrator establish options for entry of the game by entities, such as people, who did not purchase any goods or services from the vendor. This opens the promotion to non-purchasing third parties. All parties playing on the gaming web site are exposed to advertising at the gaming web site.

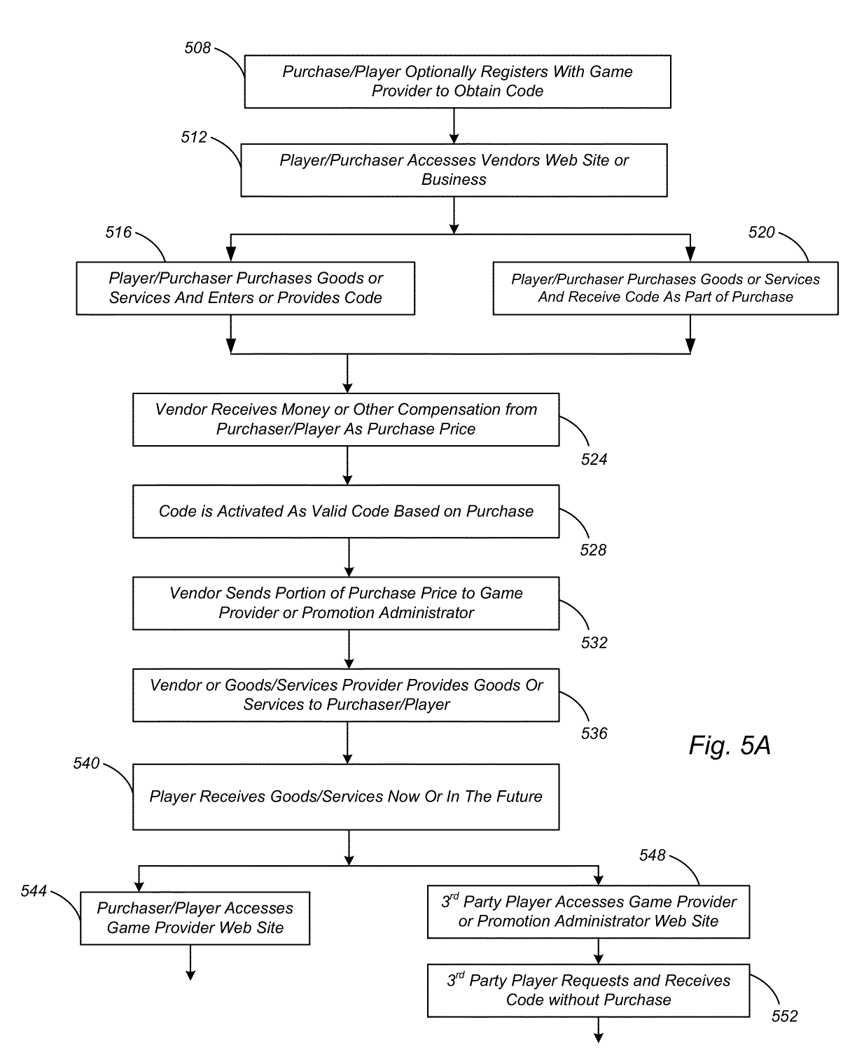

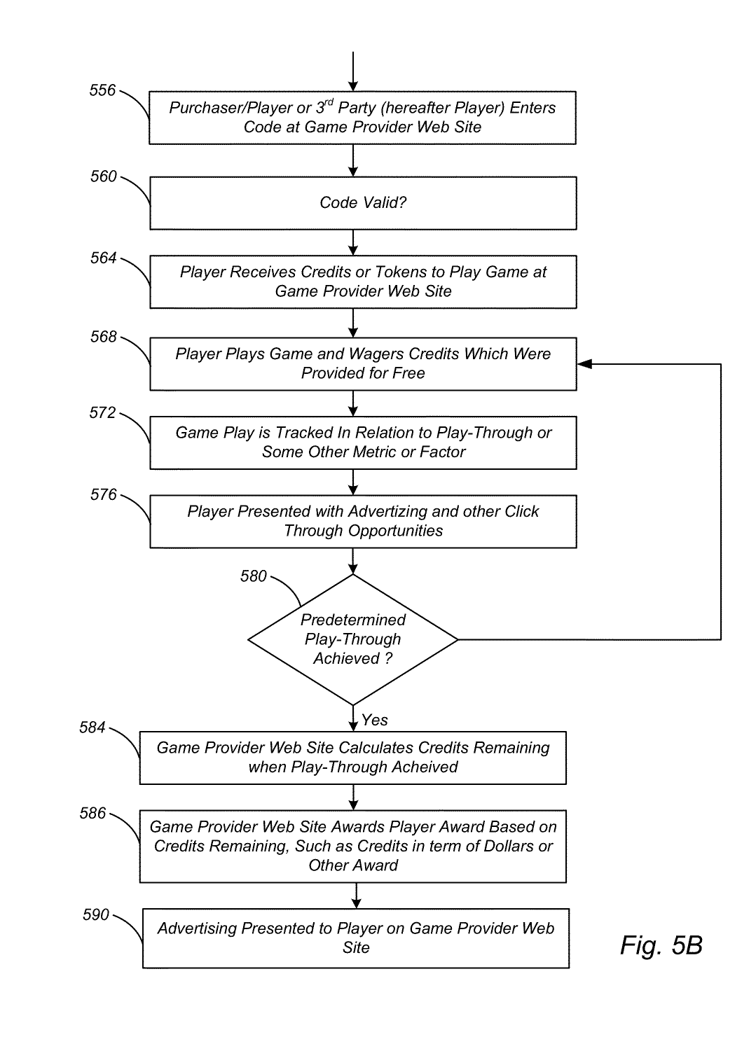

In reference to FIG. 5, illustrated is an operation flow diagram of an example method of operation. As with the other figures set forth above, this is but one possible method of operation and based on the following, other methods of operation are possible. To start the process, or at some point within the process, at a step 508 the user purchase/player may register with the game provider or the promotion administrator. The registration occurs such as by creating a user or player account and obtaining a identifying code or identification number.

At a step 512 the purchaser/player accesses the vendors web site or business for the purpose of purchasing goods or services. The goods or services may include but are not limited to physical goods, such as but not limited to watches, jewelry, electronics, art, or a combination thereof which meet a certain combined threshold dollar value, digital goods such as digital songs, movies or games, or services such as any type service, travel, lodging, food, restaurant dining, investments, or gaming and wagering, or any other type of goods or services. Then at a step 516 the purchaser/player purchases goods or services and enters the code or other identifying information established as part of step 508. This then establishes the purchase, which includes the grant of credits to the purchaser/player, as being associated with the purchaser/player.

Alternatively, at step 520 the purchaser/player purchases goods or services and receives a code as part of the purchase. The code is also known by the game provider and the purchaser/player may use the code as set forth below to play and obtain the credits. It is contemplated that the code and or purchase information is exchanged between the vendor and either the game provider or the promotion administrator such that the game provider knows when a purchase with associated credits has been made.

At a step 524 the vendor receives money or other compensation from the purchaser/player as part of the purchase. In exchange from the money the purchaser/player receives not only the product/services but also the credits.

Upon payment at step 524 the code or credits in the account are activated. The activation may occur by the player, or the gaming web site upon occurrence of a qualified purchase. Alternatively, the message from the vendor (e-commerce web site) may perform the activation. This occurs at a step 528. Activation may occur in any manner known in the art. At a step 532 the vendor sends a portion of the purchase price or some other form of compensation to the game provider or promotion administrator. In one embodiment a percentage of the purchase price is transferred to the game provider or promotion administrator. In one configuration, only purchases that are click-through purchases or which the game provider code is entered qualify for money to be sent back to the game provider. In other embodiments, all code associated purchases qualify for compensation from the vendor to the game provider or promotion administrator. In one configuration, multiple items may be combined to meet a threshold dollar limit which qualifies for the grant of credits.

As is understood, the payment of monitory value may be made in batches, such as on a monthly basis. If this is the configuration for payment, then the vendor may send a number (amount) or other notification when a purchase occurs so that credits or codes may be provided or activated.

At a step 536 the vendor or the goods/services provider sends the goods or provides the services to the purchaser/player and a step 540 the purchaser/player receives the goods or services now or in the future. The purchase is not limited to an online purchase as a code could be entered or assigned at a check-out counter.

After step 540 the operation may advance to either 544 or 548. At a step 544 the purchaser/player accesses the game provider web site. Alternatively at step 548 the non-purchaser of goods/services may access the game provider or promotion administrator web site (or by phone/mail) and at step 552 they may request and receive a code or credits without making a purchase of goods or services. Steps 548 and 552 may not be available in all embodiments.

Turning now to FIG. 5B, the purchaser/player or third party, (hereafter collectively purchaser/player accesses the game provider web site or the promotion administrator web site enters the code to obtain the credits. At a step 560 a determination is made whether the code is valid. This may occur by performing a database look up or other query to a remote web server. Upon validation that the code is valid at a step 564 the player receives credits or token to play. For example, if the game play is in a physical casino at gaming machines or game table, tokens or chips may be provided.

At a step 568 the player may connect to the game provider web site and play the game with the credits or wagers which were provided. In one embodiment the game may be other than a wagering game, such as any other type game played against a computer or other people or any game of fun which the purchaser/player sufficiently values the credits to cause the purchaser/player to purchase the goods/services from the vendor to obtain the code. The credits may also be credits for gold or things (such as weapons or keys, in a virtual game world).

Next, at a step 572 the game play is tracked in relation to one or more other factors. These other factors may comprise play through, time played, score earned, level reached, any particular hands received, particular combinations received, or any other factor. One or more of these factors may comprise the predetermined event as set forth in the claims below. As set forth above, play through is the amount wagered and a predetermined value or amount of play through may be required for the player to be entitled to an award. This award may be provided regardless of whether the player made a purchase with a vendor. In one embodiment 300% play through must occur such that the player must wager 300% of the amount of credits received. Hence if the player receives 100 credits, they must wager 300 credits to meet the play through requirement. In other embodiment the play through could be set to any value such as but not limited to 500%, 150%, or 275%.

At a step 576 the player is presented with advertising during play of the game or other web based information and content. This advertising may cause the player to move away from the game web site, but in so doing the game provider web site may generate additional revenue. The player may return at any time to resume play.

At a decision step 580 the game provider server or system determines if a predetermined amount of play through has been achieved. If the player has not achieved the require play through or other qualifying factor, the operation returns to step 568. If the player is out of credits play will stop. In one embodiment the player could purchase additional credits to achieve play through.

If at step 580 the player does achieve the predetermined play through amount then the operation advances to step 584 and the game provider web site calculate the credits remaining when the play through is achieved. The amount of credits may determine an award. In one embodiment if any credits remain, the player receives an award. In one embodiment if a predetermined number of credits remain, the player receives an award. In one embodiment if any credits remain, the player receives the number of credits as a cash or credit aware, the credit aware usable to purchase goods at the vendor. In other embodiments other means for rewarding the player may occur, or no award may be provided. These awards may optionally be available to players who requested and received credits but did not make a purchase. At a step 586 the game provider awards the player based on the play through. Any payment or award system is contemplated for use. At step 590, advertising is continually provided to the player and such advertising may be targeted to specific topics associated with the player such as personal information, location information, prior purchase information, style or type of game played or any other factor.

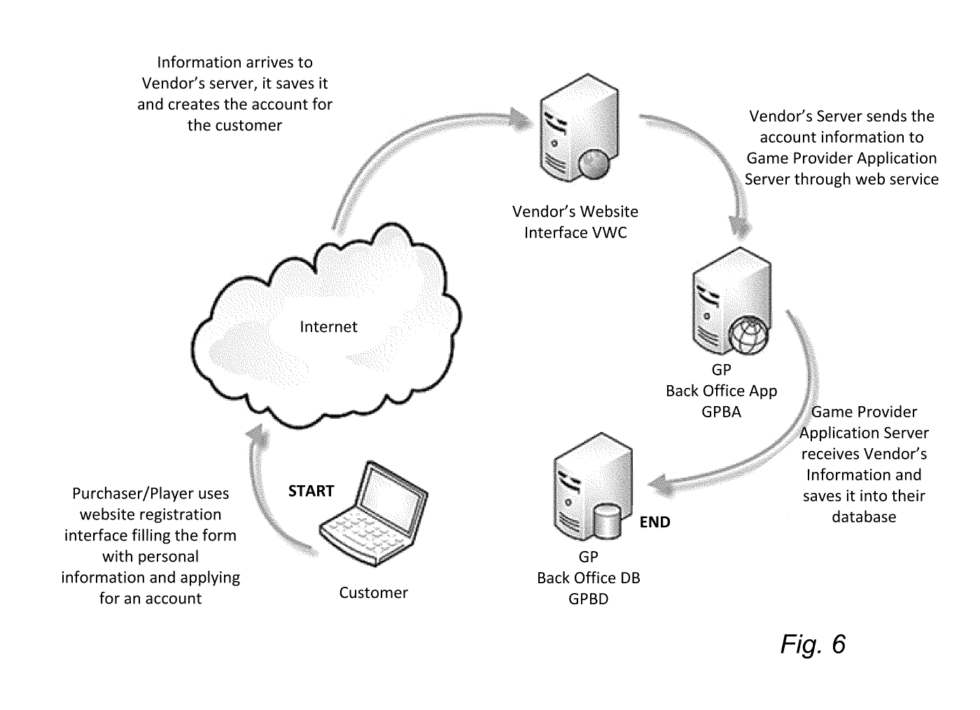

FIG. 6-11 illustrate operational diagrams of the processes and sequences, with associated hardware, that may be used to perform the method disclosed herein. These operational diagrams are provided as one example configuration of the various systems and as such, the various embodiments which are contemplated to enable the method of this application are not limited to these exact configurations. The following figures discuss exemplary systems and methods for performing the following: registration, processing traffic received from the game provider, installing the game from a game provider game site (game could also be played ‘on-line’ without install), installation, purchase of a product or service, and game play.

The following keys provide information about the letter codes and abbreviations used in FIG. 6-11.

### System Objects

| Object | Function |
|---|---|
| Vendor (V) | Online Store |
| Game Provider (GP) | Website, Installer and Game Interface |
| Drop Shipper (DS) | Vendor Goods Delivery |
| Payment Processor (PP) | Payment reception, validator, and manager |
| Purchaser/Player Client | Product Purchaser |
| (V. Client) | |
| Game Credits (G. | Free Game Credits obtained by purchasing |
| Credits) | products |

### System Servers by Object

List of hardware and server required to complete functions

| System | | |
|---|---|---|
| Object | Server | Example Optional System Req. |
| Vendor | Website Interface | OS Linux, 250 GB HD, 4 GB RAM, |
| (V) | (VWC) | Gigabit Network, 100 MB Internet |
| | | Bandwidth |
| Game | Website (GPW) | OS Linux, 250 GB HD, 4GB RAM, |
| Provider | | Gigabit Network, 100 MB Internet |
| (GP) | | Bandwidth |
| | Back Office | OS Linux, 500 GB HD, 16 GB RAM, |
| | Application (GPBA) | Gigabit Network, 100 MB Internet |
| | | Bandwidth |
| | Back Office | OS Linux, 500 GB HD, 32 GB RAM, |
| | Database (GPBD) | Gigabit Network, 100 MB Internet |
| | | Bandwidth |
| | Download/Update | OS Linux, 250 GB HD, 8 GB RAM, |
| | (GPD) | Gigabit Network, 20 MB Internet |
| | | Bandwidth |
| | RNG (GPR) | OS Linux, 500 GB HD, 128 GB RAM, |
| | | Gigabit Network, 100 MB Internet |
| | | Bandwidth |
| Drop | Web Services | Third Party Server Owned by Drop |
| Shipper | (DSW) | Shipper/Vendor |
| (DS) | | |
| Payment | Web Services | Third Party Server Owned by Payment |
| Processor | (PPW) | Processor |
| (PP) | | |

FIG. 6 illustrates an operational diagram for player registration. In FIG. 6 the registration of players could occur as shown. The potential customer can arrive on to vendor's website from different traffic sources, such as from an advertisement, through a social media website, or organic such as independently. Potential purchaser/player would access the vendors URL as shown.

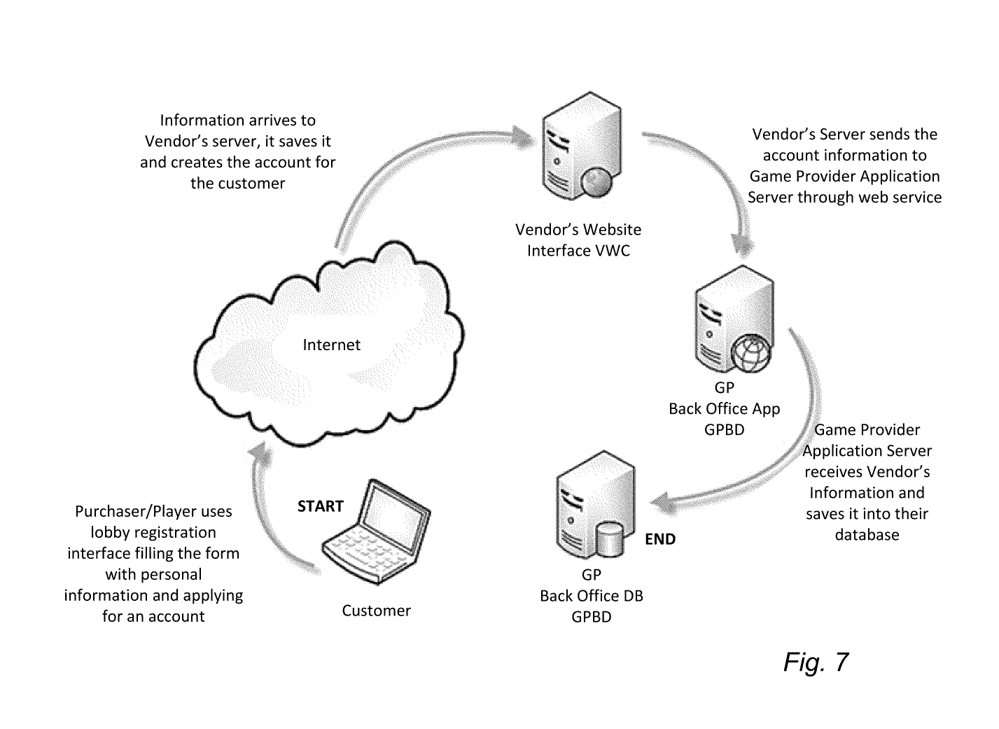

FIG. 7 illustrates an operational diagram for processing traffic received via game provider. In this example embodiment a potential customer can arrive on to game provider's website in various ways including an advertisement, through a social media website, or organic such as independently. The game provider URL entices the potential purchaser/customer to download game application and in the process explains the promotion. The registration process via the game provider will be identical to the vendors. The game provider acts as a portal for registering new customers for the vendor.

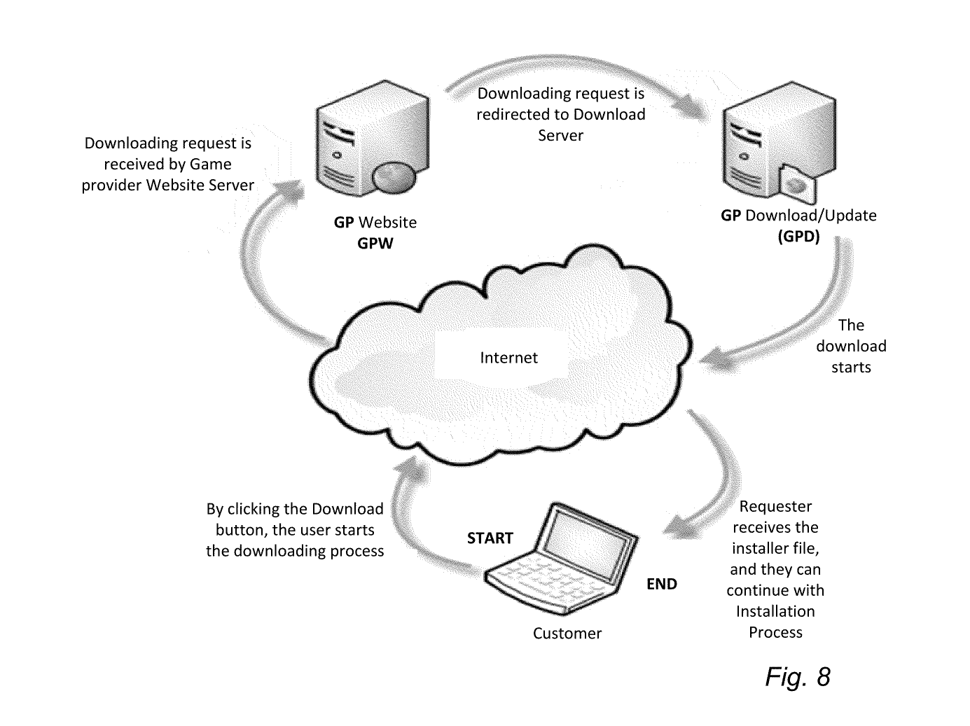

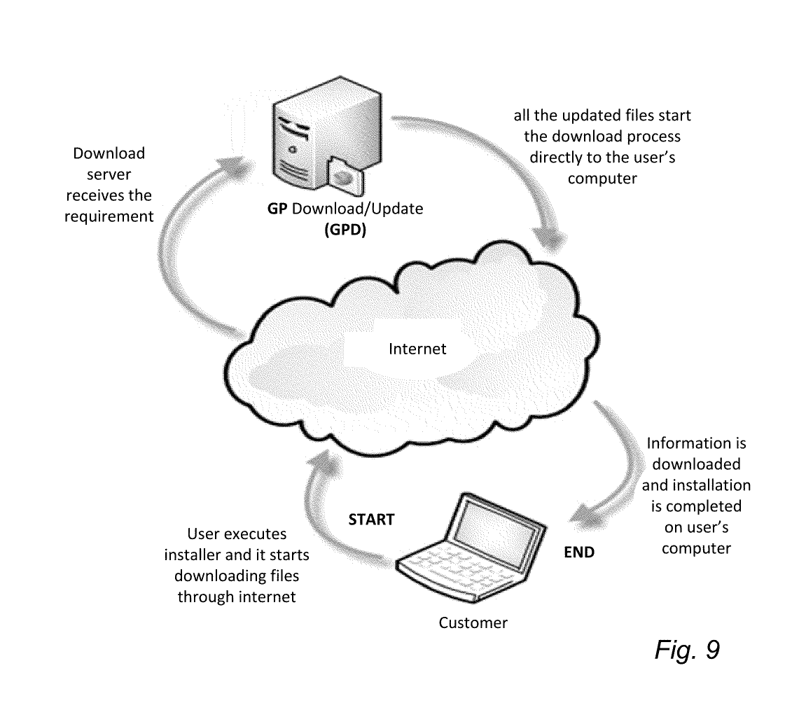

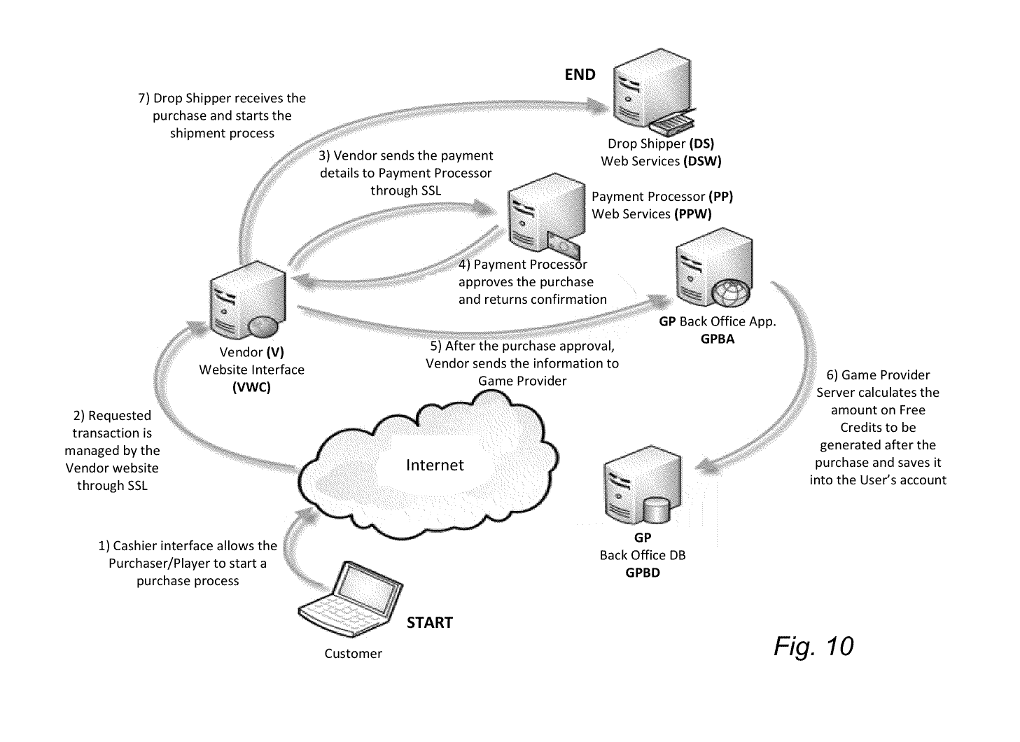

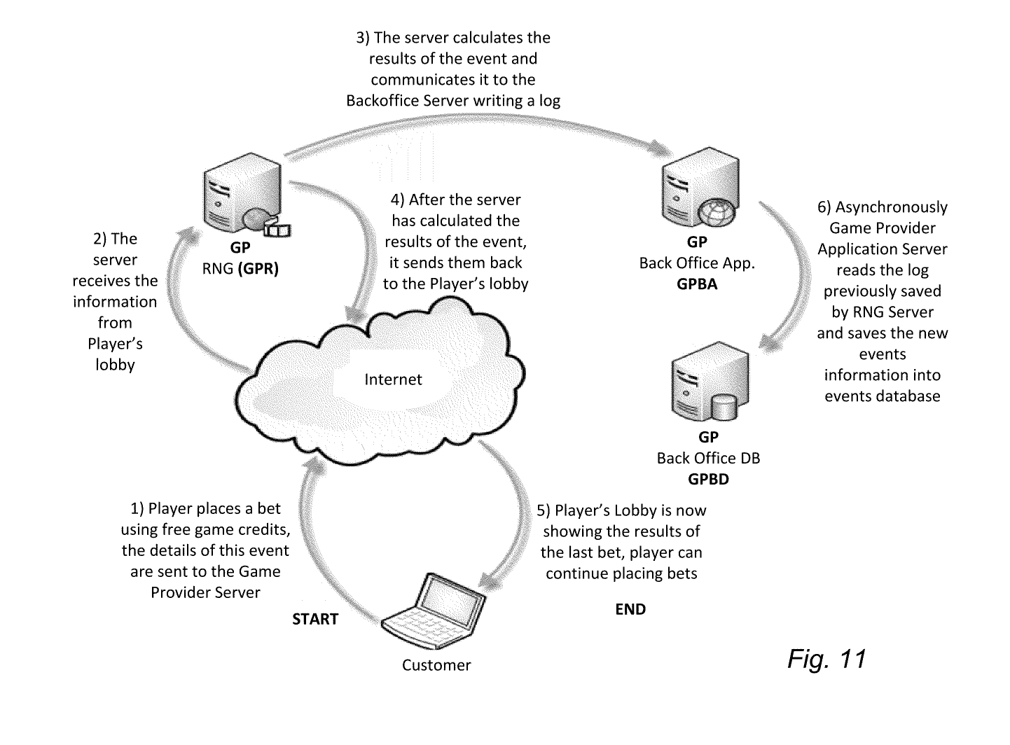

FIG. 8 illustrates an operational diagram for downloading the game, data, or other content. FIG. 9 illustrates an operational diagram for installing the game, data, or other content to the player or purchaser (user) computing device. FIG. 10 illustrates an operational diagram for making a purchase at a vendor web site or other location to obtain credits. FIG. 11 illustrates an operational diagram for downloading the game, data, or other content.

### Exemplary Promotion Discount Amount, Payout Amounts, and Hold Calculations

To ensure that a purchaser will not gain an unfair advantage over the system by making repeat purchases and cash-ins (returns) with the same funds steps can be taken to ensure that the prize money paid out to different customers is varying and equates to the 25% the vendor was prepared to give to his customers in the form of a discount.

In one example arrangement, if the average rtp (return to player) is set at 92% on a slot or other game, that equates to every $100 in credits wagered, the game earns $8 on average or an 8% hold. By implementing a play through restriction of 12.5× (times) the 100 credits×12.5=$1250×8% hold=$100. Thus, a 12.5× play through requirement would be needed to result in $100 credits earned and $100 credits paid out back to customers. Therefore requiring a 30 times play through ensures that the promotional game will always have favorable odds, meaning favorable for the game provider in that the game provider will not payout more than it takes in. To ensure that at least 25% gets paid out to customers (purchasers) in the form of cash prizes, non-cash awards, or variable cash rebates, adjustments may be made to the volatility of the game. In this way, the game provider is able to influence the amount of the prizes and how much money or how many awards pass the play through requirement resulting in an average of 25% return back to the customers in the form of prize money. It should be understood that these values can be adjusted.

| Initial Purchase | | |
|---|---|---|
| Customer Purchase | 100 | |
| Free Credits | 100 | |
| Total Start | 100 | |
| Wagers Required | $3,000 | play through |
| | | requirement |
| Return To Player % | 92.00% | |
| House Hold | 8.00% | |
| Results typical of | | |
| Standard Deviation of a | | |
| Slot Game | | |
| Return to player: | | 92.000% |
| Mean: | | 0.92 |
| Standard Deviation: | | 9.15 |

VOLATILITY TABLE
95% CONFIDENCE
VALUE FOR 1 CREDIT BET

| | | | | Profit | |
|---|---|---|---|---|---|
| | | | | Range | |
| Games played | Range +/− | Max | Min | Max | Min |
| 2,481 | +/−36.005 | 128.158 | 56.148 | 43.852 | −28.158 |
| Results when | | | | | |
| volatility is | | | | | |
| increased slightly | | | | | |
| Return to player: | | 92.000% | | | |
| Mean: | | 0.92 | | | |
| Standard | | 12.2 | | | |
| Deviation: | | | | | |
| 3,317 | +/−41.519 | 133.672 | 50.635 | 49.365 | −33.672 |
| Players who will | | | 25.190% | | |
| progress to | | | | | |
| Cash-out Option | | | | | |

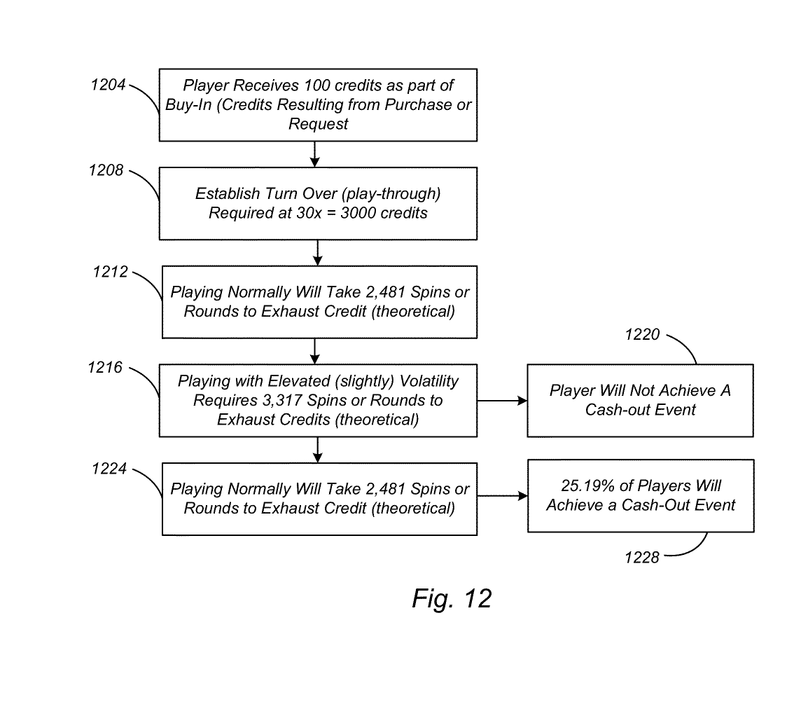

FIG. 12 illustrates a flow chart of an example calculation. This is but one possible scenario for play-through. Any of these numeric values may be adjusted to suit the promotion. At a step 1204 the player receives credits, in this case, 100, as part of the buy in or purchase. At a step 1208 the system establishes turn over (which may be referred to as play-through) required. In this example the play through is 30 times play through, which results in 3000 credit play through. In other embodiment other turn over multipliers may be established.

At a step 1212 the calculation estimates that playing normally by the player will takes 2481 spins or other rounds to exhaust the credits. At a step 2126 if the play occurs with elevated volatility the play would require 3317 spins or rounds to exhaust credits. The slightly elevated volatility is within 1 Standard Deviation from the mean which accounts for 68.27% of all possible results from playing the game.

As a result, as shown at step 1220 the player will not achieve a cash-out event because the predetermined event will not occur. Alternatively at a step 1224 without the elevated volatility, normal play will take 2481 spins or round to exhaust the recite. From step 1224 the process advances to step 1228 and the calculation reveals an average payout to players is 25.19%. Result here is that with a slight increase in volatility from a typically standard volatility set it is very possible that 25% of players will in fact obtain the necessary turnover to afford a cash-out event.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method for promoting sales of a product or service, comprising:
receiving notice from a network accessible e-commerce site that sale of a qualifying product or service in exchange for a payment has occurred;
receiving a portion of the payment from the network accessible e-commerce site;
responsive to the receiving notice, granting the purchaser credits or a code redeemable for credits;
sending purchase data including data regarding the credits or code to a server associated with a promotion, the promotion including a game playable with the credits or the code redeemable for credits;
presenting a game to the purchaser at a network accessible game server;
accepting, from the purchaser, credits granted as part of the purchase to thereby allow the purchaser to play the game, the credits accepted as opportunities to play the game;
responsive to the purchaser receiving an winning outcome, providing additional credits or opportunities to play the game;
monitoring game play of the purchaser; and
responsive to the purchaser meeting one or more predetermine criteria, presenting an award to the purchaser based on the number of credits remaining after meeting the one or more predetermined criteria.

2. The method of claim 1 wherein the predetermined criteria comprises achieving a predetermined play-through amount which is a multiple of the number of credits provided to the purchaser for the purchase.

3. The method of claim 1 wherein the credits or code are do not have monetary value.

4. The method of claim 1 wherein the game comprises a wagering game that does not provide a monitory payout in response to game play but only in response to the meeting one or more predetermine criteria and having one or more credits remaining after meeting the one or more predetermined criteria.

5. The method of claim 1 wherein the credits are provided for free to the purchaser upon purchase of the product for sale.

6. The method of claim 1 wherein credits for game play may be obtained for free by a non-purchaser upon request by the non-purchaser.

7. The method of claim 1, further comprising providing at least of portion of the payment paid to the network accessible e-commerce site to an entity associated with the promotion.

8. An e-commerce method performed by a promotion operator, the method comprising:
establishing a communication link with a e-commerce seller, the e-commerce seller having an e-commerce web site configured to provide a purchaser at the e-commerce web site with credits for game play upon purchase at the e-commerce web site, the purchase including a purchase payment;
upon a qualifying purchase at the e-commerce web site:
providing credits to the purchaser;
receiving, a portion of the purchase payment from the e-commerce web site;
presenting a game at a network accessible gaming web site, the game playable using the credits;
monitoring one or more aspects of game play for a predetermine event;
upon detecting the predetermined event, determining if the player has any credits remaining;
responsive to the player having credits remaining at the time of the detection of the predetermined event, providing the player with an award.

9. The method of claim 8 wherein the award is a monitory amount representative of the number of credits remaining upon the detection of the predetermined event.

10. The method of claim 8 wherein the credits only have monetary value when the player achieves the predetermined event.

11. The method of claim 8 further comprising providing credits to a non-purchasing player upon written request by the non-purchasing player.

12. The method of claim 8 wherein the award comprises a gift card to the e-commerce web site.

13. The method of claim 8 further comprising accepting payment from the player for additional credits at the network accessible gaming web site, additional credits usable to play the game.

14. The method of claim 8 wherein the game comprises a game selected from the group of games consisting of poker, slots, keno, and bingo.

15. A system for presenting selling a product in connection with a promotion comprising:
a processor in communication with a memory, the processor configured to execute machine readable code;
a memory configured to store machine readable code in a non-transitory state, the machine readable code configured to:
establishing communication with an e-commerce web site, the e-commerce web site providing a purchaser at the e-commerce web site with credits for game play upon the purchase at the e-commerce web site of product or service, the purchase including a purchase payment made to the e-commerce web site by the purchaser;
upon a purchase at the e-commerce web site, providing credits to the purchaser;
accepting a portion of the purchase payment from the e-commerce web site;
presenting a game to the purchaser at a network accessible gaming web site, the game playable using the credits;
monitoring one or more aspects of game play by the player for a predetermine event;
upon detecting the predetermined event, determining if the player has any credits remaining; and
responsive to the player having credits remaining at the time of the detection of the predetermined event, providing the player with an award.

16. The system of claim 15 wherein the predetermined event comprises a requirement that the purchaser wager a predetermined amount of game wagers.

17. The system of claim 15 wherein the predetermined event comprises one of the follow: game play for predetermined period of time, a number of hands played where the game comprises a card game, or a number of round play where the game comprises slots.

18. The system of claim 15 wherein the credits are provided to an account associated with the purchaser or through use of a code, which is redeemable for credits.

19. The system of claim 15 wherein the credits do not have a monetary value and can only be used to play the game.

20. The system of claim 15 wherein the product or service is a gift card or a certificate for a future purchase of a product or service.

21. The system of claim 15 wherein an amount of the award is based on the number of credits remaining at the time of the detection of the predetermined event.
